(19) United States
(12) Patent Application Publication
(10) Pub. No.: US 2023/0254155 A1
(43) Pub. Date: Aug. 10, 2023

(54) REGISTRATION TERMINAL, VERIFICATION TERMINAL, MANAGEMENT SYSTEM AND PROGRAM

(71) Applicant: NIPPON TELEGRAPH AND TELEPHONE CORPORATION, Tokyo (JP)

(72) Inventors: Shigenori OHASHI, Musashino-shi (JP); Keita SUZUKI, Musashino-shi (JP); Tatsuro ISHIDA, Musashino-shi (JP); Masayoshi CHIKADA, Musashino-shi (JP); Shigeru FUJIMURA, Musashino-shi (JP); Atsushi NAKADAIRA, Musashino-shi (JP)

(73) Assignee: NIPPON TELEGRAPH AND TELEPHONE CORPORATION, Tokyo (JP)

(21) Appl. No.: 18/011,689

(22) PCT Filed: Jul. 1, 2020
(86) PCT No.: PCT/JP2020/025823

§ 371 Date: Dec. 20, 2022

(51) Int. Cl. H04L 9/32

(52) U.S. Cl. CPC H04L 9/3247; H04L 9/3213

(57) ABSTRACT

A registration terminal according to the present embodiment is connectable to a first distributed ledger network and a second distributed ledger network. The registration terminal includes a registration unit, a first control unit, and a second control unit. The registration unit registers a file in an external storage service. The first control unit generates a registration transaction including a file identifier assigned to the file by the storage service and a verification key, and transmits the registration transaction to the first distributed ledger network. The second control unit generates a token transaction related to generation of a token and including a signature object message including the file identifier and a signature value obtained by digitally signing the signature object message with a signature key, and transmits the token transaction to the second distributed ledger network.

### TECHNICAL FIELD

The present invention relates to a registration terminal, a verification terminal, a management system and a program using a distributed ledger technology.

### BACKGROUND ART

In transactions of cryptocurrency represented by bitcoin (registered trademark), blockchains are used as a type of decentralized distributed ledger technology. Since the blockchains have high robustness against falsification, use of the blockchains for various purposes such as smart contracts for conducting transactions other than those of the cryptocurrency has been studied. Examples of a programmable blockchain that can handle smart contracts include Ethereum, which can execute a general-purpose distributed application.

The distributed ledger technology capable of implementing various smart contracts has a data structure in which transactions are grouped into blocks and the blocks are associated with each other by a hash, and thus is not suitable for management of a file having a large data size.

As a distributed file management method, there is a storage that manages a file with a unique identifier (ID) created from a content hash or the like (see, for example, Non Patent Literature 1). In addition, there is also a method of registering a file in the storage and recording the ID of the file in a distributed ledger and managing the file (see, for example, Non Patent Literature 2).

### CITATION LIST

### Non Patent Literature

Non Patent Literature 1: Juan Banet, “IPFS-Content Addressed, Versioned, P2P File System (DRAFT 3)”, [online], [searched on Feb. 27, 2020], Internet <URL: https://ipfs.io/ipfs/QmR7GSQM93Cx5eAg6a6yRzNde1FQv7uL6X1o4k7zrJa3L X/ipfs.draft3.pdf>

Non Patent Literature 2: Mathis Steichen et al., “Blockchain-Based, Decentralized Access Control for IPFS”, [online], [searched on Feb. 27, 2020], Internet <URL: https://www.researchgate.net/publication/327034734_Blockchain-Based_Decentralized_Access_Control_for IPFS>

### SUMMARY OF INVENTION

### Technical Problem

In a case where separate systems such as a distributed ledger and a distributed file storage are used together in cooperation with each other on the user side, the two systems have different functions provided to a user and different ID systems, and thus it is not possible to guarantee that information held in the systems is always consistent.

For example, assuming that a token of the distributed ledger and the ID of a file are managed in association with each other, it is not possible to determine which of a file ID registered in one token contract and the same file ID registered in another token contract is correct.

In a case where it is determined that the contract previously generated and confirmed in the distributed ledger is regarded as legitimate, it is necessary to search an infinite number of contracts and extract all the tokens described therein, which is not realistic. If a new contract is created for management of file association, a relationship depending on the contract is formed. As a result, in a structure that logically depends on a particular application, the particular application may be a single point of failure.

The present invention has been made in view of the above circumstances, and an object thereof is to provide a registration terminal, a verification terminal, a management system, and a program capable of implementing robust and flexible information management.

### Solution to Problem

In order to achieve the above object, a registration terminal according to one aspect of the present invention is connectable to a first distributed ledger network and a second distributed ledger network. The registration terminal includes a registration unit, a first control unit, and a second control unit. The registration unit registers a file in an external storage service. The first control unit generates a registration transaction including a file identifier assigned to the file by the storage service and a verification key, and transmits the registration transaction to the first distributed ledger network. The second control unit generates a token transaction related to generation of a token and including a signature object message including the file identifier and a signature value obtained by digitally signing the signature object message with a signature key, and transmits the token transaction to the second distributed ledger network.

In addition, a verification terminal according to one aspect of the present invention is connectable to a first distributed ledger network and a second distributed ledger network. The verification terminal includes a first extraction unit, a second extraction unit, and a verification unit. The first extraction unit refers to the second distributed ledger network and extracts a signature object message including a file identifier to be verified and a signature value of the signature object message by using access information to a generated token. The second extraction unit refers to the first distributed ledger network and extracts a verification key associated with the same file identifier as the file identifier. The verification unit verifies the signature value by using the verification key.

In addition, a management system according to one aspect of the present invention can access each of a first distributed ledger network, a second distributed ledger network, and a storage service, and includes a registration terminal and a verification terminal. The registration terminal includes a registration unit, a first control unit, and a second control unit. The registration unit registers a file in the storage service. The first control unit generates a registration transaction including a file identifier assigned to the file by the storage service and a verification key, and transmits the registration transaction to the first distributed ledger network. The second control unit generates a token transaction related to generation of a token and including a signature object message including the file identifier and a signature value obtained by digitally signing the signature object message with a signature key, and transmits the token transaction to the second distributed ledger network. The verification terminal includes a first extraction unit, a second extraction unit, and a verification unit. The first extraction unit refers to the second distributed ledger network and extracts a signature object message including a file identifier to be verified and a signature value of the signature object message by using access information to the issued token. The second extraction unit refers to the first distributed ledger network and extracts the same file identifier as the extracted file identifier and a verification key. The verification unit verifies the signature value by using the verification key.

### Advantageous Effects of Invention

That is, according to the present invention, robust and flexible information management can be implemented.

### BRIEF DESCRIPTION OF DRAWINGS

FIG. 1 is a conceptual diagram of a management system according to the present embodiment.

FIG. 2 is a block diagram illustrating a registration terminal according to the present embodiment.

FIG. 3 is a block diagram illustrating a verification terminal according to the present embodiment.

FIG. 4 is a sequence diagram illustrating an example of registration processing of the management system according to the present embodiment.

FIG. 5 is a sequence diagram illustrating an example of association verification processing of the management system according to the present embodiment.

FIG. 6 is a diagram illustrating an example of a signature object message according to the present embodiment.

### DESCRIPTION OF EMBODIMENTS

Hereinafter, a registration terminal, a verification terminal, a management system and a program according to an embodiment of the present disclosure will be described in detail with reference to the drawings. Note that, in the following embodiment, parts denoted by the same reference signs perform similar operations, and repeated description will be omitted.

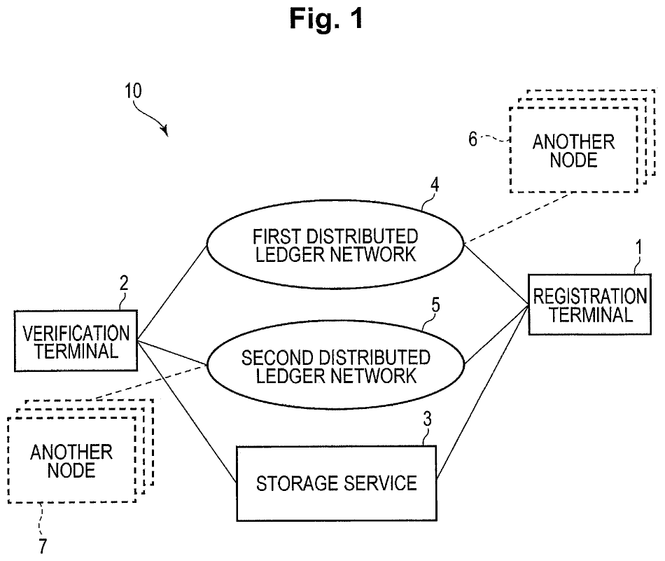

A management system according to the present embodiment will be described with reference to the conceptual diagram of FIG. 1.

A management system 10 according to the present embodiment includes a registration terminal 1, a verification terminal 2, a storage service 3, a first distributed ledger network 4, and a second distributed ledger network 5.

The registration terminal 1 is a terminal that registers a file in the storage service 3, and is connectable to the storage service 3, the first distributed ledger network 4, and the second distributed ledger network 5. In addition, the registration terminal 1 manages an account connectable to each of the storage service 3, the first distributed ledger network 4, and the second distributed ledger network 5, a signature key associated with the account, and a verification key corresponding to the signature key. Note that, as the signature key, a common value may be used for the storage service 3, the first distributed ledger network 4, and the second distributed ledger network 5, or different values may be used. The signature key may be stored in the registration terminal 1, or may be managed in a storage place different from the registration terminal 1, such as a cloud server, a dedicated device, or a sheet of paper.

The verification terminal 2 is a terminal that verifies association between a file registered by the registration terminal 1 in the storage service 3 and a token generated on the second distributed ledger network 5, and can access the storage service 3, the first distributed ledger network 4, and the second distributed ledger network 5. Similarly to the registration terminal 1, the verification terminal 2 also manages a signature key associated with an account connectable to the first distributed ledger network 4 and the second distributed ledger network 5.

The storage service 3 is a service in which the registration terminal 1 registers a file and manages the registered file. When a file is registered, the storage service 3 issues a file ID for the file. The file ID is an identifier for uniquely identifying the file, and is also referred to as a file identifier. The storage service 3 may be a centralized storage, in which a server (not illustrated) manages files, or may be a decentralized storage such as an interplanetary file system (IPFS) or Swarm, in which terminals involved in maintenance of the storage service 3 are distributed and manage files in a peer to peer (P2P) network.

The first distributed ledger network 4 is a network using a decentralized distributed ledger technology, which requires no specific administrator. Here, the first distributed ledger network 4 is assumed to be a blockchain network such as Namecoin, which can register data in a key-value store format. However, the first distributed ledger network 4 is only required to use a distributed ledger technology that can manage at least two elements in association with each other in a distributed ledger and does not include processing registered a posteriori by a specific administrator in the process of verifying a transaction, executing the transaction, and registering the transaction to the ledger.

The second distributed ledger network 5 is a network using a logical centralized distributed ledger technology, which requires a specific administrator. Here, the second distributed ledger network 5 is assumed to be a blockchain network such as EOS or Ethereum, which can implement decentralized applications (DApps) related to application of a blockchain, such as smart contracts. However, the second distributed ledger network 5 is only required to be a network using a distributed ledger technology in which registration and management of a program executed by a transaction are performed a posteriori by a specific administrator.

Note that, in the present embodiment, the first distributed ledger network 4 and the second distributed ledger network 5 are assumed to be different independent networks, but the first distributed ledger network 4 and the second distributed ledger network 5 may be configured by one distributed ledger network as long as a layer of data processing that is inherently provided in an infrastructure and requires no specific administrator and a layer of data processing that is executed by a program registered a posteriori by a specific administrator can be used in distinction from one another.

Note that each of the registration terminal 1 and the verification terminal 2 may have a node function for belonging to the first distributed ledger network 4 and the second distributed ledger network 5 and maintaining each network. The node function is a function of performing verification processing and confirmation processing on a transaction, and updating and retaining ledger information (block information, a state database, and the like).

Note that, in addition to the registration terminal 1 and the verification terminal 2, a terminal that substitutes for the node function (referred to as another node) may exist in the first distributed ledger network 4 and the second distributed ledger network 5. In the example of FIG. 1, there may be another node 6 that maintains the first distributed ledger network 4, and there may be another node 7 that maintains the second distributed ledger network 5. Each of the registration terminal 1 and the verification terminal 2 does not have to have the node function in a case where the another node 6 and the another node 7 exist that each substitute for the node function. Note that, in the present embodiment, a case where each of the registration terminal 1 and the verification terminal 2 also executes the node function will be described.

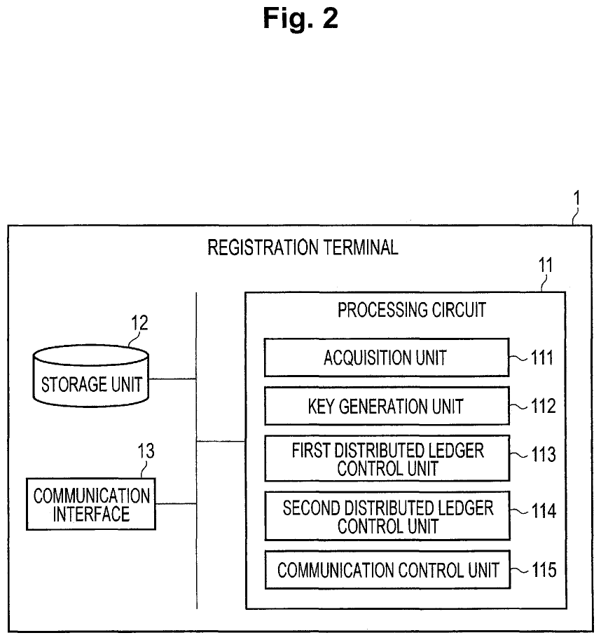

Next, the registration terminal 1 according to the present embodiment will be described with reference to the block diagram of FIG. 2.

The registration terminal 1 includes a processing circuit 11, a storage unit 12, and a communication interface 13. The processing circuit 11 includes an acquisition unit 111, a key generation unit 112, a first distributed ledger control unit 113, a second distributed ledger control unit 114, and a communication control unit 115.

The acquisition unit 111 acquires a file to be registered in the storage service 3.

The key generation unit 112 generates a key pair of a signature key of a registrant and a verification key corresponding to the signature key, which is used for registration in the storage service 3, that is, for confirming association between the file and a token. Note that the key generation unit 112 may generate, for transaction issuance, a pair of a signature key for digitally signing a transaction and a verification key corresponding to the signature key for each of the first distributed ledger network 4 and the second distributed ledger network 5.

The first distributed ledger control unit 113 generates a registration transaction including a file ID assigned to the file by the storage service 3 and the verification key. The first distributed ledger control unit 113 transmits the registration transaction to the first distributed ledger network 4. In addition, the first distributed ledger control unit 113 executes a node function for maintaining the first distributed ledger network.

The second distributed ledger control unit 114 generates a token transaction related to token data and including a signature object message including the file ID and a signature value obtained by digitally signing the signature object message with the signature key of the registrant. The token data is data related to token issuance. The second distributed ledger control unit 114 transmits the token transaction to the second distributed ledger network 5. The second distributed ledger control unit 114 executes a node function similarly to the first distributed ledger control unit 113.

The communication control unit 115 controls data communication among the storage service 3, the first distributed ledger network 4, and the second distributed ledger network 5. In particular, in the case of performing processing of transmitting the file to the storage service 3 and receiving the file ID, the communication control unit 115 is also referred to as a registration unit.

The storage unit 12 stores ledger data of the first distributed ledger network 4 and the second distributed ledger network 5, the key pair for transaction issuance, the key pair for association certification, the file, an identifier of the registration transaction issued by the registration terminal 1 (also referred to as a registration transaction ID), access information to the token, and the like. The access information to the token is information for referring to information stored in the token or information stored in the token transaction used to generate the token, and specific examples thereof include an identifier of the token transaction (also referred to as a token transaction ID), a contract address, access interface information, and an ID allocated to the token.

The communication interface 13 is an interface for performing data communication among the storage service 3, the first distributed ledger network 4, and the second distributed ledger network 5. Since a generally used communication interface can be used as the communication interface 13, the description thereof will be omitted here.

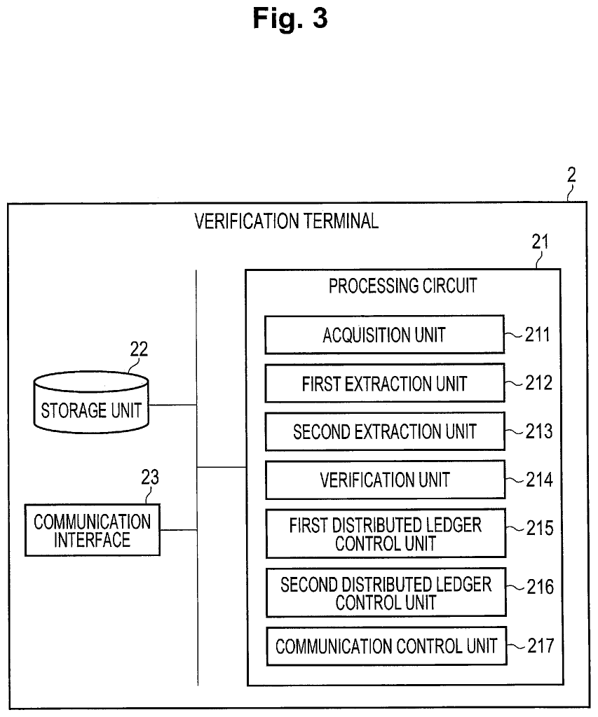

Next, the verification terminal 2 according to the present embodiment will be described with reference to the block diagram of FIG. 3.

The verification terminal 2 includes a processing circuit 21, a storage unit 22, and a communication interface 23. The processing circuit 21 includes an acquisition unit 211, a first extraction unit 212, a second extraction unit 213, a verification unit 214, a first distributed ledger control unit 215, a second distributed ledger control unit 216, and a communication control unit 217.

The acquisition unit 211 verifies information stored in a token or information stored in a token transaction used to generate the token by verification processing by the verification unit 214 to be described later, and acquires a file corresponding to a file ID from the storage service 3 in a case where the authenticity of the stored information can be confirmed.

The first extraction unit 212 refers to the second distributed ledger network 5 and extracts a signature object message including the file ID to be verified and a signature value by using access information to the token.

The second extraction unit 213 refers to the first distributed ledger network 4 and extracts a verification key associated with the same file ID as the file ID.

The verification unit 214 verifies the signature value by using the verification key.

The first distributed ledger control unit 215 and the second distributed ledger control unit 216 implement node functions similar to those of the first distributed ledger control unit 113 and the second distributed ledger control unit 114 of the registration terminal 1, respectively.

The communication control unit 217 controls data communication among the storage service 3, the first distributed ledger network 4, and the second distributed ledger network 5.

The storage unit 22 stores ledger data of the first distributed ledger network 4 and the second distributed ledger network 5, a key pair for transaction issuance, the access information to the token, and the like, and further stores the registration transaction ID as necessary.

The communication interface 23 performs substantially the same processing as the communication interface 13 of the registration terminal 1.

Note that each of the processing circuit 11 of the registration terminal 1 and the processing circuit 21 of the verification terminal 2 includes a processor such as a central processing unit (CPU) or a graphics processing unit (GPU), or an integrated circuit such as a field programmable gate array (FPGA) or an application specific integrated circuit (ASIC). Each unit of the processing circuit 11 and the processing circuit 21 described above may be implemented as one function of the processor or the integrated circuit by the processor or the integrated circuit executing a processing program.

In addition, each of the storage unit 12 of the registration terminal 1 and the storage unit 22 of the verification terminal 2 is configured by a generally used storage medium such as a hard disk drive (HDD), a solid state drive (SSD), or a flash memory, for example.

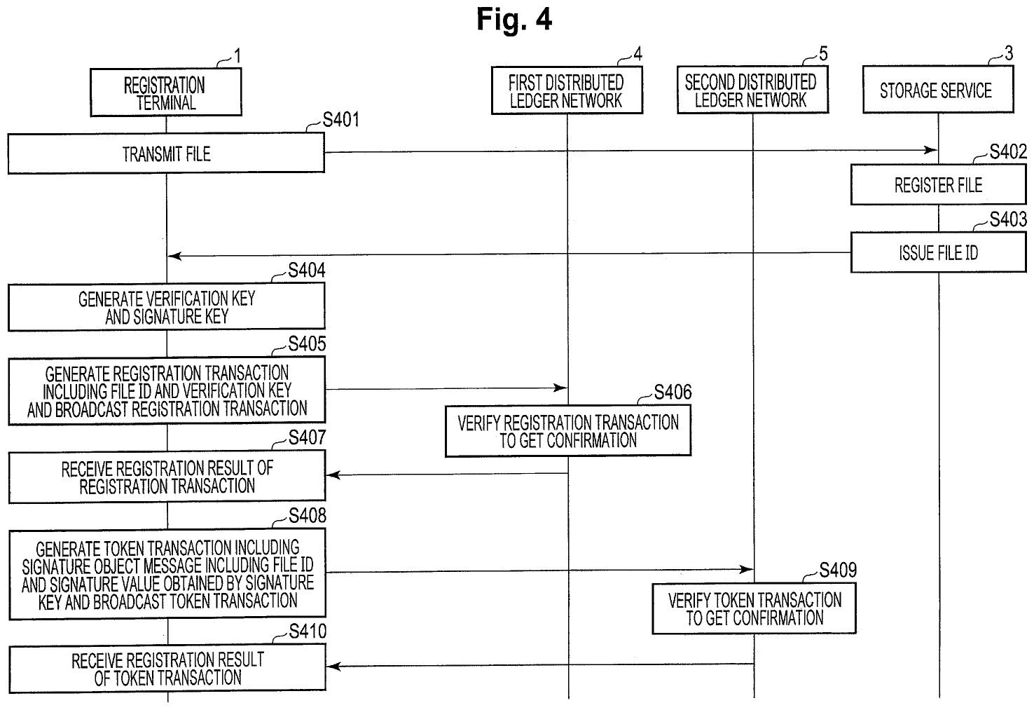

Next, file registration processing of the management system 10 according to the present embodiment will be described with reference to the sequence diagram of FIG. 4.

FIG. 4 is a sequence illustrating a time series related to data transmission and reception among the registration terminal 1, the verification terminal 2, the storage service 3, the first distributed ledger network 4, and the second distributed ledger network 5. Note that, although not illustrated, the verification terminal 2 may also participate as a node in order to maintain the distributed ledger networks.

In step S401, the acquisition unit 111 of the registration terminal 1 acquires a file from the storage unit 12 or the outside, and the communication control unit 115 transmits the file to the storage service 3.

In step S402, the storage service 3 starts registration and management of the file received from the registration terminal 1.

In step S403, the storage service 3 issues a file ID for the file and transmits the file ID to the registration terminal 1. The file ID may be, for example, a character string created from a hash value of the file, such as a fingerprint, or an ID including a phrase indicating a service provider in addition to the character string created from the hash value. Alternatively, the file ID may be an identifier such as a uniform resource identifier (URI). That is, any identifier may be issued as long as the identifier can uniquely identify the file.

When the communication control unit 115 of the registration terminal 1 receives the file ID, the processing of registering the file in the storage service 3 is completed.

In step S404, the key generation unit 112 of the registration terminal 1 generates a signature key and a verification key corresponding to the signature key, which are used for verifying association between the file ID and a token. Note that the key generation unit 112 may generate the signature key when the first file is registered in the storage service 3, and may generate only the verification key on the basis of the signature key when a registrant registers a file thereafter. In addition, when a plurality of files is registered, the key generation unit 112 may use the same key pair for the plurality of files instead of newly generating a key pair of a signature key and a verification key corresponding to the signature key for each file.

In step S405, the first distributed ledger control unit 113 of the registration terminal 1 generates a registration transaction including the file ID and the verification key. In order to make the registration transaction a valid transaction, the first distributed ledger control unit 113 digitally signs the registration transaction with a signature key generated for using the first distributed ledger network 4, and broadcasts the digitally signed registration transaction to the first distributed ledger network 4.

In step S406, a plurality of terminals each having a node function in the first distributed ledger network 4 verifies the registration transaction by a consensus algorithm. If the registration transaction satisfies a predetermined requirement, the registration transaction is taken into a block. Here, assuming that the registration transaction satisfies the predetermined requirement, the registration transaction is confirmed by the first distributed ledger network 4.

In step S407, the first distributed ledger control unit 113 of the registration terminal 1 receives the registration result of the registration transaction from the first distributed ledger network 4. The registration result includes, for example, the registration transaction, the confirmation result (True or False or a status code), and the block number of the block in a case where the registration transaction is registered in the block.

In step S408, the second distributed ledger control unit 114 generates a token transaction including a signature object message related to token issuance and including the file ID and a signature value obtained by digitally signing the signature object message with the signature key. In order to make the token transaction a valid transaction, the second distributed ledger control unit 114 digitally signs the token transaction with a signature key generated for using the second distributed ledger network 5, and broadcasts the digitally signed token transaction to the second distributed ledger network 5.

In step S409, the second distributed ledger network 5 verifies the token transaction by a consensus algorithm. If the token transaction satisfies a predetermined requirement, the token transaction is taken into a block. Here, assuming that the token transaction satisfies the predetermined requirement, the token transaction is confirmed by the second distributed ledger network 5.

In step S410, the registration terminal 1 receives the registration result of the token transaction from the second distributed ledger network 5. The registration result includes, for example, the token transaction, the confirmation result (True or False or a status code), and the block number of the block in a case where the token transaction is registered in the block.

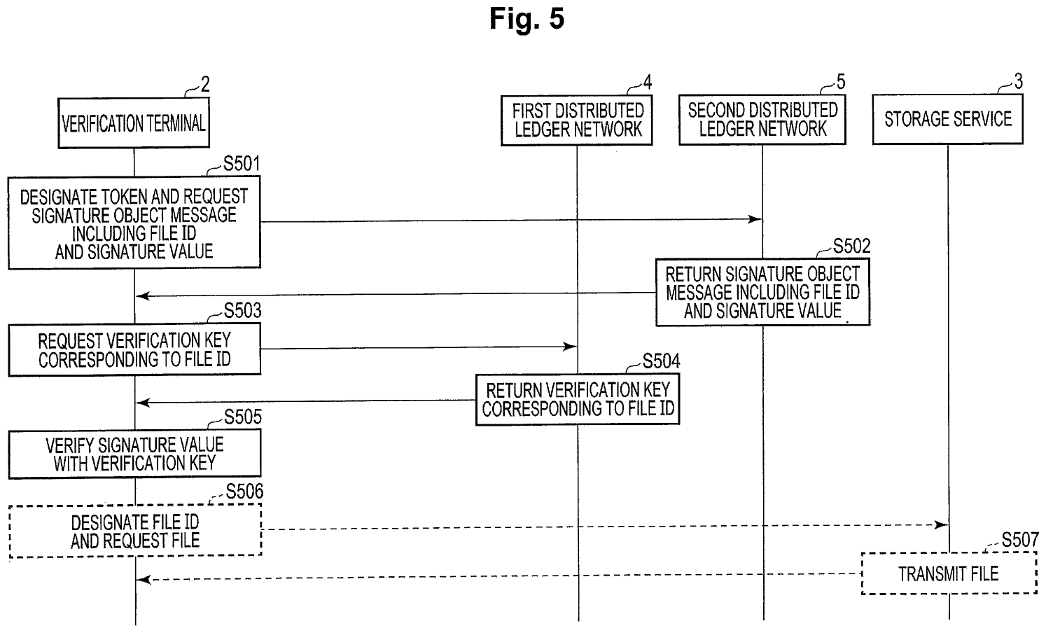

Next, processing of verifying association between a file and a token in the management system 10 according to the present embodiment will be described with reference to the sequence diagram of FIG. 5.

FIG. 5 is a sequence illustrating a time series of data exchange related to the verification terminal 2, the storage service 3, the first distributed ledger network 4, and the second distributed ledger network 5. Note that, although not illustrated, the registration terminal 1 may also participate as a node in order to maintain the distributed ledger networks.

Furthermore, in FIG. 5, for convenience of description, the “request” and the “return” in the sequence are illustrated as accessing the first distributed ledger network 4 and the second distributed ledger network 5, but can be implemented by internal processing of the verification terminal 2 without directly accessing the first distributed ledger network 4 and the second distributed ledger network 5. This is because, in a case where the verification terminal 2 participates as a node in the first distributed ledger network 4 and the second distributed ledger network 5, the verification terminal 2 itself serves as a part of the distributed ledger network. That is, it is only required to extract transactions, various data, and the like that match a request of a verifier by referring to the distributed ledger retained by the verification terminal 2.

In step S501, the first extraction unit 212 of the verification terminal 2 designates access information to a token to be verified, and requests the second distributed ledger network 5 for a signature object message including a file ID and a signature value by using an API or a token transaction of the corresponding token.

In step S502, the signature object message including the file ID and the signature value are returned from the second distributed ledger network 5 in response to the request from the verification terminal 2. Note that the processing in steps 501 and S502 may be executed as processing in which the first extraction unit 212 of the verification terminal 2 extracts the file ID and the signature value with reference to the second distributed ledger network 5.

In step S503, the second extraction unit 213 of the verification terminal 2 requests the first distributed ledger network 4 for a verification key associated with the same file ID as the extracted file ID by a registration transaction.

In step S504, the first distributed ledger network 4 returns the verification key corresponding to the file ID in response to the request from the verification terminal 2. Note that the processing in steps 503 and S504 may be executed as processing in which the second extraction unit 213 of the verification terminal 2 extracts the file ID and the signature value with reference to the first distributed ledger network 4. Furthermore, for example, in a case where the first distributed ledger network 4 is implemented by Bitcoin Core, it is sufficient that the ledger is searched for the registration transaction matching the registration transaction ID, and the verification key associated with the file ID is acquired.

In step S505, the verification unit 214 of the verification terminal 2 verifies the signature value with the verification key.

Note that, in a case where the verification of the signature value is successful, for example, the verification terminal 2 may acquire the file on the basis of the token.

Specifically, in step S506, the acquisition unit 211 of the verification terminal 2 designates the file ID and requests the file from the storage service 3.

In step S507, it is sufficient that the storage service 3 searches the database for the file corresponding to the file ID and transmits the file to the verification terminal 2.

Note that the registration terminal 1 may directly or indirectly share the registration transaction ID with the verification terminal 2 in the first distributed ledger network 4, and the verification terminal 2 may store the shared registration transaction ID in the storage unit 22. The second extraction unit 213 can efficiently extract the verification key by referring to the shared registration transaction ID stored in the storage unit 22 in step S503. For example, in a case where a distributed ledger network of bitcoin is used as the first distributed ledger network 4, sharing the registration transaction ID is useful when the verification key is extracted.

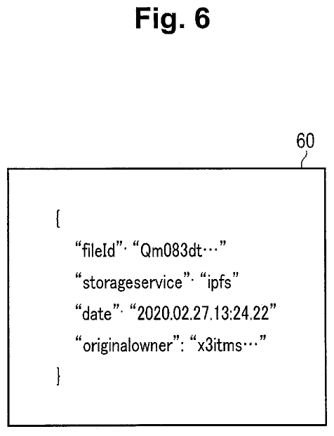

Next, an example of a signature object message digitally signed by a signature key will be described with reference to FIG. 6.

A signature object message 60 illustrated in FIG. 6 is, for example, a message described in a data field of a token transaction. Here, the signature object message 60 includes items of “fileId” indicating a file ID, “storageservice” indicating the type of the storage service 3, “date” indicating a date, and “originalowner” indicating an original owner (for example, an author) of the file. The “storageservice” may indicate an access destination such as a server domain or a protocol. Note that the signature object message 60 is not limited thereto, and may include other items. For example, in addition to “date”, an item of a random number may be added to the signature object message 60 in order to make the signature object message unique. By adding the item of the random number, the signature object message can be easily identified even if there is a plurality of signature object messages including the same content.

The second distributed ledger control unit 114 of the registration terminal 1 digitally signs the signature object message 60 with the signature key, and includes the signature value in the token transaction. The verification unit 214 of the verification terminal 2 can verify the authenticity of the fact that the file corresponding to the file ID has been registered by the registration terminal by verifying the signature value with the verification key associated with the file ID.

According to the embodiment described above, in a case where a file having a large data size is managed by a storage service, a file ID and a verification key are managed by a decentralized distributed ledger network, which requires no specific administrator, and a signature object message related to token issuance and including the file ID and a signature value obtained by the signature key are managed by a logical centralized distributed ledger network, which implements DApps and requires a specific administrator.

Even in a case where DApps using the file and having various policies increase or policies of DApps change, a failure such as a program bug or intentional or accidental destruction by an administrator in a service (contract) by one DApp does not become a single point of failure and does not affect verification of the authenticity of another service because a basic mechanism for verification is managed in a decentralized distributed ledger network. As a result, robust and flexible information management can be implemented.

The instructions shown in the processing procedures shown in the above-described embodiment can be executed by a computer on the basis of a program as software.

In short, the present invention is not limited to the above-described embodiment as it is, and can be embodied by modifying components without departing from the gist of the invention when implemented. In addition, appropriately combining a plurality of components disclosed in the above embodiment makes it possible to form various inventions. For example, some components may be deleted from all the components shown in the embodiment. Furthermore, components in different embodiments may be appropriately combined.

### REFERENCE SIGNS LIST

10 Management system
1 Registration terminal
2 Verification terminal
3 Storage service
4 First distributed ledger network
5 Second distributed ledger network
6, 7 Another node
11, 21 Processing circuit
12, 22 Storage unit
13, 23 Communication interface
60 Signature object message
111, 211 Acquisition unit
112 Key generation unit
113, 215 First distributed ledger control unit
114, 216 Second distributed ledger control unit
115, 217 Communication control unit
115 Distributed ledger control unit
212 First extraction unit
213 Second extraction unit
214 Verification unit

1. A registration terminal connectable to a first distributed ledger network and a second distributed ledger network, the registration terminal comprising a processing circuit configured to:
register a file in an external storage service;
generate a registration transaction including a file identifier assigned to the file by the storage service and a verification key;
transmit the registration transaction to the first distributed ledger network;
generate a token transaction related to generation of a token and including a signature object message including the file identifier and a signature value obtained by digitally signing the signature object message with a signature key
transmit the token transaction to the second distributed ledger network.

2. A verification terminal connectable to a first distributed ledger network and a second distributed ledger network, the verification terminal comprising a processing circuit configured to:
to the second distributed ledger network and extracts a signature object message including a file identifier to be verified and a signature value of the signature object message by using access information to an issued token;
refer to the first distributed ledger network and extracts a verification key associated with a same file identifier as the file identifier; and
verify the signature value by using the verification key.

3. The verification terminal according to claim 2, wherein the first distributed ledger network is a decentralized blockchain network, which requires no specific administrator, and the second distributed ledger network is a logical centralized blockchain network, which requires a specific administrator.

4. A management system comprising a registration terminal and a verification terminal that are capable of accessing each of a first distributed ledger network, a second distributed ledger network, and a storage service,
the registration terminal including a processing circuit configured to:
register a file in the storage service;
generate a registration transaction including a file identifier assigned to the file by the storage service and a verification key;
transmit the registration transaction to the first distributed ledger network; and
generate a token transaction related to generation of a token and including a signature object message including the file identifier and a signature value obtained by digitally signing the signature object message with a signature key;
transmit the token transaction to the second distributed ledger network,
the verification terminal including a processing circuit configured to:
refer to the second distributed ledger network and extracts a signature object message including a file identifier to be verified and a signature value of the signature object message by using access information to the token;
refer to the first distributed ledger network and extracts a verification key associated with a same file identifier as the file identifier; and
verify the signature value by using the verification key.

5-6. (canceled)

7. The registration terminal according to claim 1, wherein the first distributed ledger network is a decentralized blockchain network, which requires no specific administrator, and the second distributed ledger network is a logical centralized blockchain network, which requires a specific administrator.
